(19) United States
(12) Patent Application Publication
(10) Pub. No.: US 2008/0101248 A1
(43) Pub. Date: May 1, 2008

(54) Methods, systems and computer program products for selective network management in a network having multiple active routes to a common destination that are keyed by different combinations of parameters

(75) Inventors: John L. Hildebrand, Hillsborough, NC (US); Komal G. Khungar, Morrisville, NC (US); Peter J. Marsico, Chapel Hill, NC (US); Jonathan J. Palmer, Durham, NC (US)

Correspondence Address: JENKINS, WILSON, TAYLOR & HUNT, P. A., 3100 TOWER BLVD., Suite 1200, DURHAM, NC, 27707, US

(73) Assignee: Tekelec

(21) Appl. No.: 11/605,941

(22) Filed: Nov. 29, 2006

Related U.S. Application Data
(60) Provisional application No. 60/855,726, filed on Oct. 31, 2006.

(51) Int. Cl. G06F 11/00

(52) U.S. Cl. 370/248

(57) ABSTRACT

The subject matter described herein includes methods, systems, and computer program products for selective network management in a network having multiple active routes to a common destination that are keyed by different combinations of parameters. According to one aspect, the subject matter described herein includes a method for controlling distribution of network management messages concerning the status of a signaling link by provisioning a routing node with a primary route to a destination and at least one exception route to the destination wherein the primary route and the exception route are keyed by different combinations of signaling message parameters. The method includes receiving network management messages concerning the status of the destination on a linkset corresponding to the exception route, updating the status of the exception route in a route table maintained by the routing node, and suppressing the broadcasting of network management messages concerning the status of the destination to nodes adjacent to the routing node.

### RELATED APPLICATIONS

This application claims the benefit of U.S. Provisional Patent Application Ser. No. 60/855,726 filed Oct. 31, 2006; the disclosure of which is incorporated herein by reference in its entirety.

### TECHNICAL FIELD

The subject matter described herein relates to improved network management procedures. More specifically, the subject matter relates to methods, systems, and computer program products for selective network management in a network having multiple active routes to a common destination that are keyed by different combinations of parameters.

### BACKGROUND

In many telecommunications networks, such as SS7 networks, it may be desirable to maintain multiple routes to a destination, including a primary route and one or more exception routes. Each route may be keyed by different combinations of message parameters. For example, the primary route may be keyed by destination point code (DPC) only. The exception routes may be keyed by one or more parameters in addition to the DPC. For example, different exception routes may be provisioned in a route table for different originating point codes (OPCs) in combination with the DPC. The routing algorithm may be structured such that when a route lookup is performed for a message, the parameters in the message are first compared to the exception routes to determine whether the message matches any of the exception routes. If the parameters in the message match any of the exception routes, the message is routed over the outbound links that correspond to the exception route. If the parameters in the message match only the default route, the message is routed over the default route. Thus, exception routes and default routes implement a routing hierarchy.

One problem with using multiple routes that share a DPC in a hierarchical manner is that conventional signaling system 7 (SS7) network management procedures are DPC-based. For example, when a routing node, such as a signal transfer point (STP), detects the failure of a signaling link that connects the routing node to a destination, the routing node broadcasts network management messages, such as transfer prohibited (TFP) messages, concerning the destination to all of its neighbors. While broadcasting network management messages to all neighbors is effective for DPC only routing, such a procedure can result in unnecessarily prohibiting destinations and excessive signaling message traffic in networks where hierarchical routing is used. Other problems associated with applying conventional destination based network management procedures to networks that use hierarchical or exception routing include the inability to communicate specific information about exception routes between nodes capable of recognizing such information, the inability to selectively test exception routes, and the inability to implement network management for tiered quality of service arrangements.

Accordingly, a need exists for methods, systems, and computer program products for selective network management in a network having multiple active routes to a common destination that are keyed by different combinations of parameters.

### SUMMARY

The subject matter described herein includes methods, systems, and computer program products for selective network management in a network having multiple active routes to a common destination that are keyed by different combinations of parameters. According to one aspect, the subject matter described herein includes a method for controlling distribution of network management messages concerning the status of a signaling link by provisioning a routing node with a primary route to a destination and at least one exception route to the destination wherein the primary route and the exception route are keyed by different combinations of signaling message parameters. The method includes receiving network management messages concerning the status of the destination on a linkset corresponding to the exception route, updating the status of the exception route in a route table maintained by the routing node, and suppressing the broadcasting of network management messages concerning the status of the destination to nodes adjacent to the routing node.

The subject matter described herein may be implemented using a computer program product comprising computer executable instructions embodied in a computer readable medium. Exemplary computer readable media suitable for implementing the subject matter described herein include chip memory devices, disc memory devices, application specific integrated circuits, programmable logic devices, and downloadable electrical signals. In addition, a computer program product that implements a subject matter described herein may reside on a single device or computing platform or maybe distributed across multiple devices or computing platforms.

### BRIEF DESCRIPTION OF THE DRAWINGS

The subject matter described herein will now be explained with reference to the accompanying drawings of which:

FIG. 1 is a flow chart illustrating an exemplary process for controlling distribution of network management information concerning an exception route according to an embodiment of the subject matter described herein;

FIG. 2 is a network diagram illustrating exemplary messages exchanged in controlling distribution of network management information concerning an exception route according to an embodiment of the subject matter described herein;

FIG. 3 is a flow chart illustrating an exemplary process for controlling distribution of route status information for an exclusive route according to an embodiment of the subject matter described herein;

FIG. 4 is network diagram illustrating exemplary messages and network nodes for controlling distribution of status information concerning an exclusive route according to an embodiment of the subject matter described herein;

FIG. 5 is a flow chart illustrating an exemplary process for exchanging exception route status update messages according to an embodiment of the subject matter described herein;

FIG. 6 is a network diagram illustrating exemplary nodes and messages for exchanging status information regarding exception routes according to an embodiment of the subject matter described herein;

FIG. 7 is a flow chart of an exemplary process for providing tiered signaling message routing quality of service and for selectively performing network management for the tiers according to an embodiment of the subject matter described herein;

FIG. 8 is a network diagram illustrating exemplary nodes and signaling messages exchanged in providing tiered quality of service and selectively performing network management on behalf of the tiers according to an embodiment of the subject matter described herein; and

FIG. 9 is a block diagram illustrating an exemplary internal architecture for a signaling message routing node that maintains a plurality of routes to a destination and that tests the availability of the routes according to an embodiment of the subject matter described herein.

### DETAILED DESCRIPTION

### Network Management Message Suppression for Changes in Exception Route Status

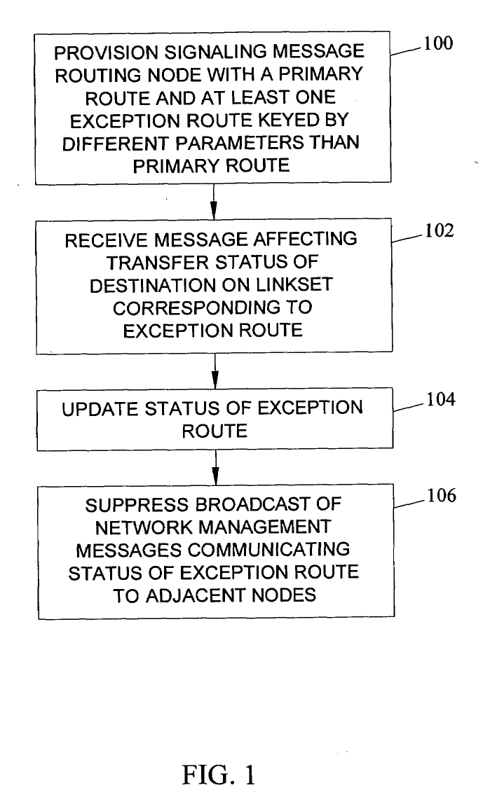

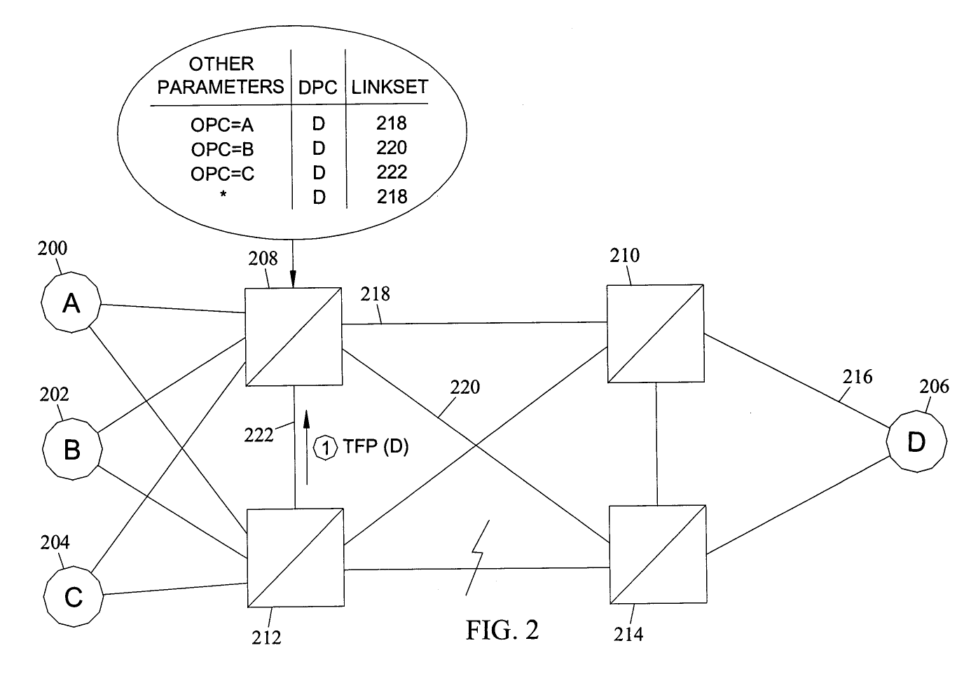

According to one aspect, the subject matter described herein includes a method for suppressing distribution of certain network management messages when information is learned concerning an exception route. FIG. 1 is a flow chart and FIG. 2 is a network diagram illustrating an exemplary process for suppressing generation of network management messages when the status of an exception route changes. Referring to FIG. 1, in step 100, a signaling message routing node is provisioned with a primary route and at least one exception route keyed by different parameters than the primary route. Referring to FIG. 2, a plurality of service switching points 200, 202, and 204 are connected to another service switching point 206 via a network of signal transfer points 208, 210, 212, and 214. In the illustrated example, signal transfer point 208 is provisioned with a routing table that includes a plurality of routes that share the same destination point code D, corresponding to node 206. Some of the routes, which are referred to as exception routes, are keyed by parameters other than the DPC. For example, one route is keyed by the originating point code of node A 200 and the destination point code of node D 206. Another route is keyed by the OPC of node B 202 and the DPC of node D 206. Yet another route is keyed by the OPC of node C 204 and the DPC of node D 206. The primary route is keyed solely by the destination point code of node D 206.

Returning to FIG. 1, in step 102, a message concerning the status of a destination is received on a linkset corresponding to an exception route. Referring to FIG. 2, a transfer prohibited (TFP) message concerning the point code of node D 206 is received on linkset 222, which corresponds to one of the exception routes. Even though the exception route for OPC=C is now unavailable and traffic from c to D will take the default route instead of the exception route, STP 208 will determine that the prohibited status concerns an exception route and suppress the broadcast of transfer prohibited or transfer restricted messages to adjacent nodes.

Returning to FIG. 1, in step 104, the status of the exception route is updated. In the example illustrated in FIG. 2, the status of the route corresponding to OPC C, DPC D will be changed to prohibited. In step 106, the broadcasting and network management messages communicating the status of the exception route to adjacent nodes is suppressed. In FIG. 2, because the TFP message was received on a linkset corresponding to an exception route and because a default route exists to the destination D, STP 208 would not send the TFP messages to node A 200, node B 202, or node C 204. As a result, unnecessary network management signaling is avoided. In the example illustrated in FIG. 1, detecting an event concerning the status of a destination includes receiving a TFP message. In another example, the linkset connecting a signaling message routing node to a destination node may fail, and detecting an event concerning the unavailability of the destination node may include detecting the linkset failure.

### Selective Network Management Message Generation for Exclusive Routing

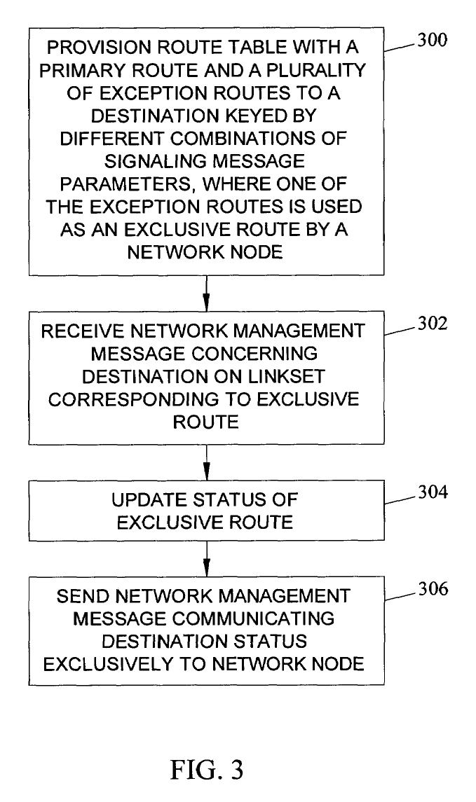

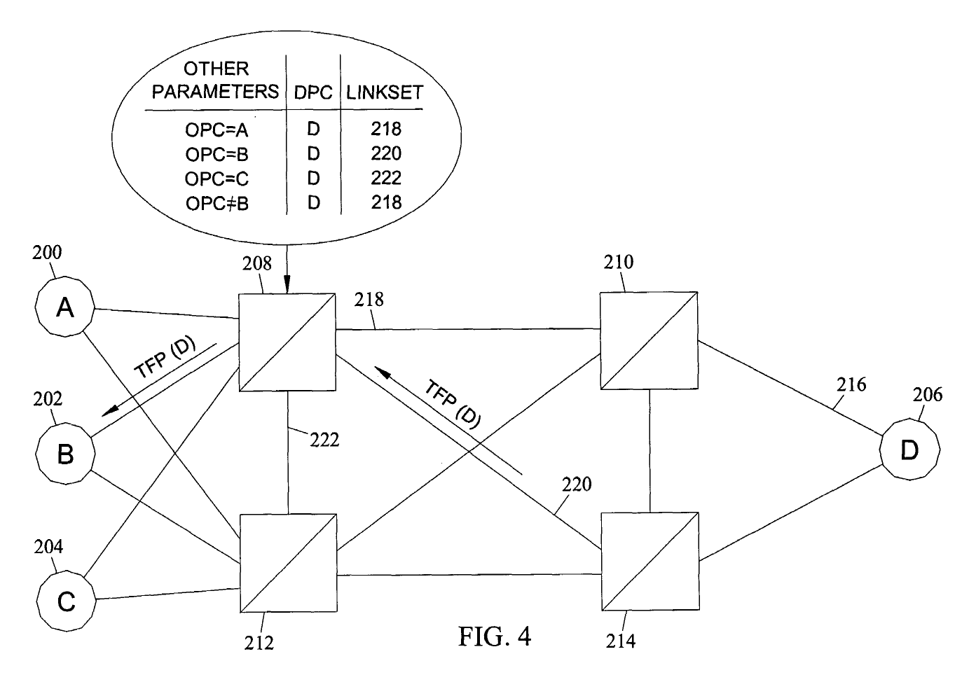

According to another aspect of the subject matter described herein, network management messages may be selectively generated for exclusive routes. As used herein, an exclusive route is a route that is used only or exclusively by a single message originator. An exclusive route may be provisioned for a single point code or group of point codes. Accordingly, the term “message originator” in this context may include more than one node. FIG. 3 is a flow chart and FIG. 4 is a network diagram illustrating an exemplary process for performing selective network management for exclusive routes according to an embodiment of the subject matter described herein. Referring to FIG. 3, in block 300, a route table is provisioned with a primary route and a plurality of exception routes to a destination. Each of the exception routes is keyed by different combinations of signaling message parameters. One of the exception routes is used as an exclusive route by a network node. Referring to FIG. 4, the route table maintained by STP 208 includes an exclusive route for APC=B, DPC=D. The exclusive route uses linkset 220. Accordingly, all traffic originating from node B 202 through STP 208 will be sent over signaling link 220. Signaling link 220 will not be used by other nodes.

Returning to FIG. 3, in step 302, a network management message concerning the destination is received on the linkset corresponding to the exclusive route. In FIG. 4, a TFP concerning D is received on linkset 220. In step 304, the status of the exclusive route is updated. In the example illustrated in FIG. 4, the status of the route corresponding to APC=B, DPC=D will be changed to unavailable. In block 306, a network management message communicating the destination status is sent exclusively to the network node corresponding to the exclusive route. In the example illustrated in FIG. 4, a TFP message concerning D is sent exclusively to node B 202. In the example illustrated in FIG. 1, detecting an event concerning the status of a destination includes receiving a TFP message. In another example, the linkset connecting a signaling message routing node to a destination node may fail, and detecting an event concerning the unavailability of the destination node may include detecting failure of the linkset.

### Exception Route Status Update and Test Messages

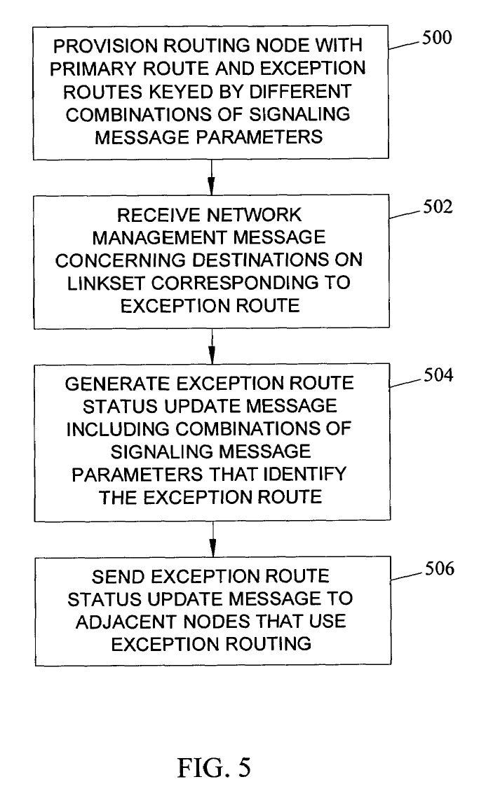

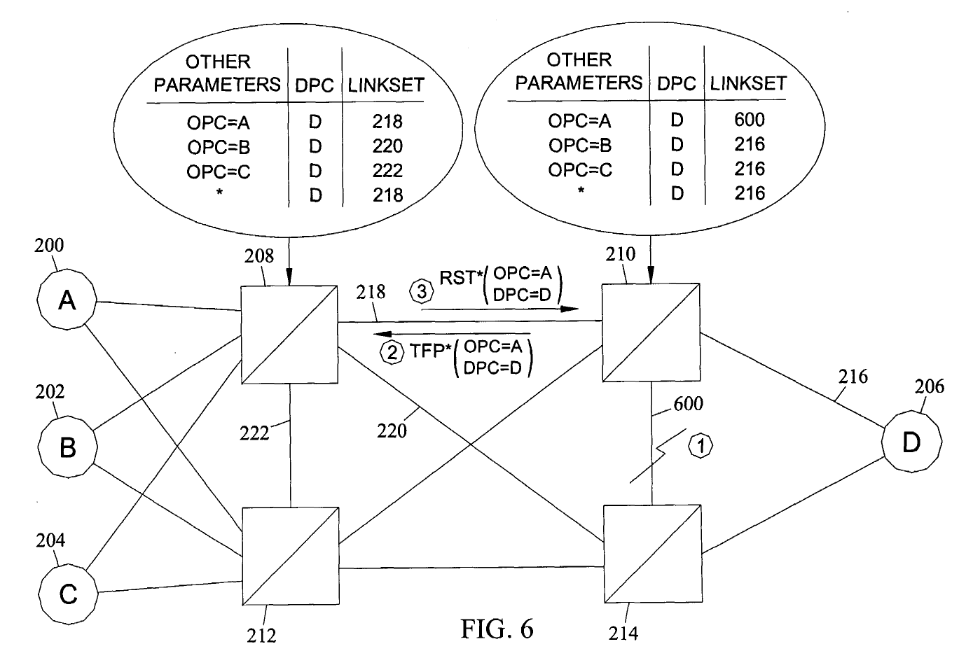

As described in the Background section above, one problem with conventional network management procedures is that the network management messages concern only destinations. In a network where exception routes are used, it may be desirable for network management messages to include information in addition to the DPC to identify an exception route. FIG. 5 is a flow chart and FIG. 6 is a network diagram illustrating an exemplary process for exchanging network management information regarding an exception route according to an embodiment of the subject matter described herein. Referring to FIG. 5, in block 500, a routing node is provisioned with a primary route and exception routes keyed by different combinations of signaling message parameters. In the example illustrated in FIG. 6, STP 208 and STP 210 each include route tables that have primary routes and exception routes keyed by different combinations of parameters.

In block 502, a change in status of an exception route is detected. Referring to FIG. 6, STP 210 detects a change in status of the exception route corresponding to OPC=A, DPC=D. In block 504, an exception route status update message including combinations of signaling message parameters that identify the exception route is generated. In FIG. 6, STP 210 generates a message, illustrated as TFP* concerning OPC=A, DPC=D. In block 506, the exception route status update message is sent to adjacent nodes that use exception routing. In the example illustrated in FIG. 6, STP 210 sends the TFP* message to STP 208.

According to another aspect of the subject matter described herein, network management status test messages concerning exception routes may also be generated. Continuing with the example illustrated in FIG. 6, in response to receiving the TFP* message, STP 208 may formulate a route set test message, illustrated as RST*, concerning OPC=A and DPC=D to explicitly test the status of the exception route. Accordingly, by using parameters in addition to the DPC, exception routes can be explicitly tested, providing that all nodes that receive the explicit test messages are capable of parsing the additional parameters in the messages.

In one embodiment, before generating and sending an exception route network management status message, such as a TFP* or RST* message, STP 208 may initiate a handshake protocol with adjacent nodes in order to determine whether a node is capable of processing these messages. Because exception route network management messages as described above are not compliant with standard network node specifications, conventional network nodes may not be capable of processing the additional information the messages contain regarding exception routes. Therefore, a specialized test message could be sent to adjacent nodes during link alignment, adjacent node restart, or other similar procedures. Conventional network nodes would fail to recognize the unknown message type and discard the message and the handshake procedure would fail. Alternatively, network nodes receiving these specialized test messages that are capable of understanding them would not discard the message. In the example illustrated in FIG. 1, detecting an event concerning the status of a destination includes receiving a TFP message. In another example, the linkset connecting a signaling message routing node to a destination node may fail, and detecting an event concerning the unavailability of the destination node may include detecting failure of the linkset.

### Tiered QoS and Network Management for Tiered QoS

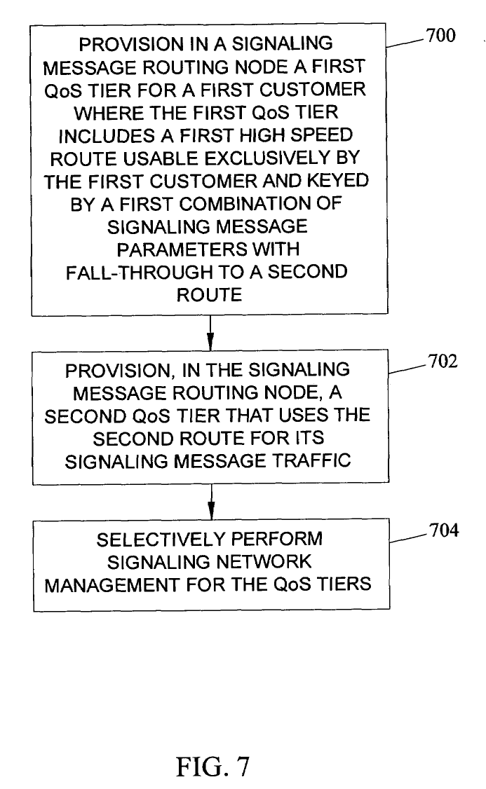

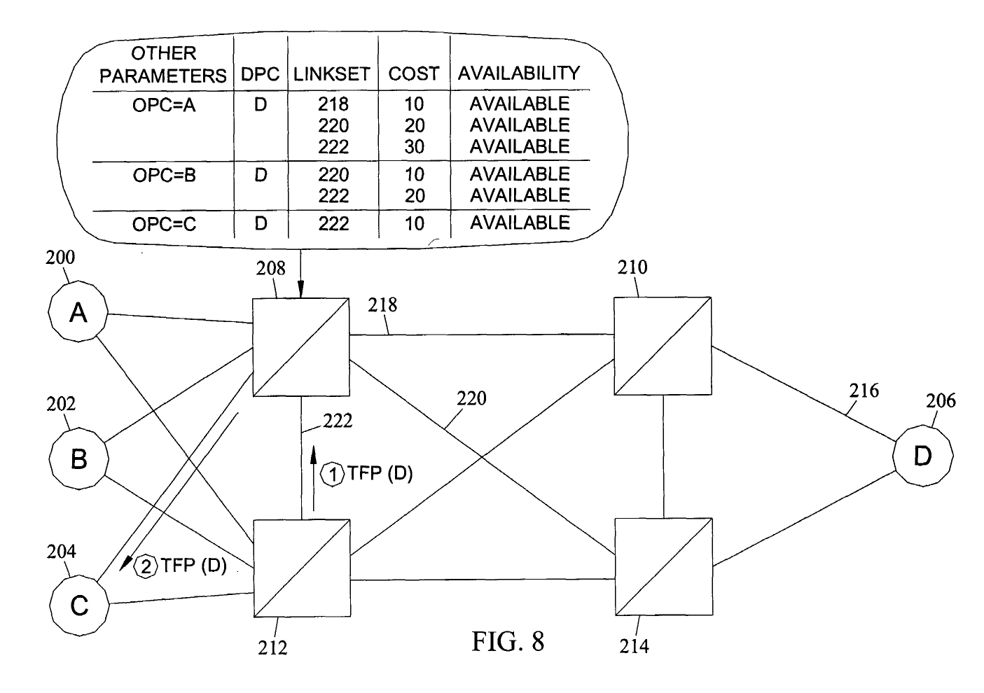

According to another aspect of the subject matter described herein, multiple signaling message routing tiers may be provisioned in a network and QoS may be selectively performed for each QoS tier. FIG. 7 is a flow chart and FIG. 8 is a network diagram illustrating an exemplary process for providing tiered QoS and selectively performing network management for QoS tiers according to an embodiment of the subject matter described herein. Referring to FIG. 7, in step 700, a signaling message routing node is provisioned to implement a first QoS tier for a first customer where the first QoS tier includes a high-speed route usable exclusively by the first customer and keyed by a first combination of signaling message parameters. Referring to FIG. 8, the first tier of QoS may correspond to OPC=A, DPC=D, such that all traffic originating from node A 200 goes over a high-speed linkset 218. The first tier may include fall through to a second route. Referring to FIG. 8, the route corresponding to OPC=A, DPC=D includes backup routing over linksets 220 and 222. The costs of the backup routes are higher than the primary routes. However, if the primary route becomes unavailable, the backup routes will be used.

In step 702, the signaling message routing node may be provisioned with a second QoS tier that includes a second route for signaling message traffic. In the example illustrated in FIG. 8, the route corresponding to OPC=B, DPC=D uses linkset 220, which is also used as a backup for the first QoS tier. In addition, the route OPC=B, DPC=D has a backup over linkset 222 with a higher cost. The example illustrated in FIG. 8, also includes a third QoS tier corresponding to OPC=C, DPC=D that only uses linkset 222. If linkset 222 fails, the route fails.

In step 704, signaling network management is performed selectively for the QoS tiers. Using the example illustrated in FIG. 8, if a TFP concerning D is received on linkset 222, a TFP message concerning D is sent exclusively to node C 206. The TFP message is not sent to node A 200 or node B 202 because the change in status does not render routing unavailable for these nodes.

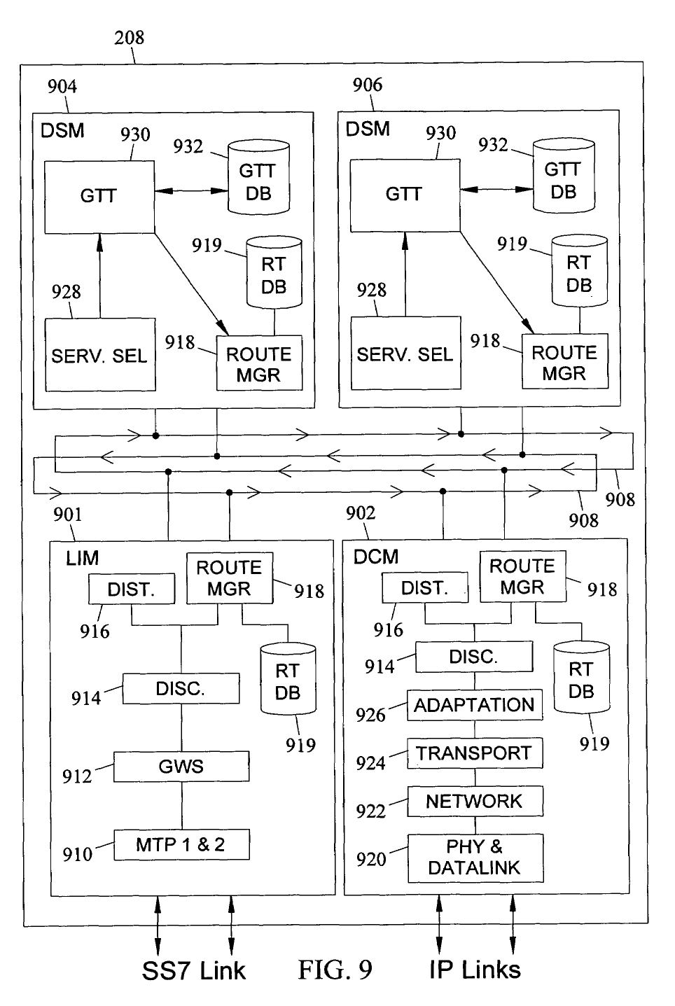

FIG. 9 is a block diagram illustrating an exemplary internal architecture for a signaling message routing node, such as STP 208, that maintains a plurality of routes to a destination and that tests the availability of the routes according to an embodiment of the subject matter described herein. Referring to FIG. 9, STP 208 includes a plurality of processing modules 901, 902, 904, and 906 connected via a counter-rotating, dual-ring bus 908. In the illustrated example, processing module 901 comprises a link interface module. Link interface module 901 interfaces with SS7 signaling links. As such, link interface module 901 includes a message transfer part level 1 and 2 function 910, a gateway screening function 912, a discrimination function 914, a distribution function 916, a route manager 918, and a route database 919.

MTP level 1 and 2 function 910 performs MTP level 1 and 2 functions, such as sequencing, error detection, and error correction for SS7 signaling messages. Gateway screening function 912 performs gateway screening operations, such as screening messages based on destination point code or additional parameters in the messages. Discrimination function 914 examines the destination point code in received SS7 messages and determines whether to forward the message to an internal processing module in routing node 208 or to routing manager 918.

For messages that require internal processing, discrimination function 914 forwards these messages to distribution function 916. Distribution function 916 distributes these messages to the appropriate internal processing module within routing node 208. For messages that require routing, discrimination function 914 sends these messages to route manager 918. Route manager 918 examines the destination point code plus any additional parameters in the signaling message, performs a lookup in route database 919 using these parameters to identify an outbound signaling link, and routes the signaling messages to the interface module associated with the outbound signaling link. Route manager 918 may also implement the network management procedures described herein for performing selective network management in a network having multiple active routes to a common destination that are keyed by different combinations of signaling message parameters.

Module 902 comprises a data communications module for sending and receiving SS7 messages over IP signaling links. In the illustrated example, module 902 includes a physical and data link layer function 920, a network layer function 922, a transport layer function 924, an adaptation layer function 926, and functions 914-919 described above with regard to module 901. Physical and data link layer function 920 may be implemented using any suitably physical and data link layer protocol, such as an Ethernet protocol. Network layer function 922 may implement any suitable network layer protocol, such as Internet protocol. Transport layer function 924 may implement any suitable transport layer protocol, such as UDP, TCP, or SCTP. Adaptation layer function 926 may implement any suitable SS7 adaptation layer protocol, such as M2PA, M3UA, SUA, or TALI, as described in the corresponding Internet Engineering Task Force requests for comments. Functions 914-919 implement the corresponding operations described above with regard to LIM 901.

Modules 904 and 906 comprise database service modules for implementing database services for received messages. In the illustrated example, each of modules 904 and 906 includes a service selection function 928, a global title translation function 930, and a global title translation database 932. Service selection function 928 receives messages from other modules over bus 908 and determines the appropriate service to be applied to the messages. In the illustrated example, the service to be applied is global title translation. Other services, such as number portability translation, application layer screening, or other database services, may be applied without departing from the scope of the subject matter described herein. Global title translation function 930 performs a lookup in global title translation database 932 to determine a destination point code to be inserted in a message based on results of the global title translation. After the appropriate destination point code is inserted in the message, global title translation function 930 forwards the message to route manager 918, which routes the message to the interface module associated with the outbound signaling link.

Table 1 shown below illustrates exemplary parameters by which different routes to the same destination may be keyed in route database 919.

TABLE 1
Route Classes
Route Classes

DPC & OPC
DPC & Originating Linkset
DPC & CIC
DPC & SI
DPC

In Table 1, it is assumed that the route in the last row corresponds to the primary route. The remaining routes represent exception routes. As can be seen from the data in Table 1, the exception routes are keyed by the same DPC as the primary route plus additional parameters. The additional parameters include parameters such as the OPC, the originating linkset, the DPC, and the SI, which are associated with all SS7 signaling messages. Other parameters, such as the CIC parameter, are associated with ISUP messages. Accordingly, route classes illustrated in Table 1 may be used to route all types of SS7 signaling messages, including ISUP messages and SCCP messages, over one of a plurality of routes to a destination maintained by a signaling message routing node. Route database 919 may comprise one or more tables, or any other suitable data structure, and may be embodied in a computer readable medium.

It will be understood that various details of the subject matter described herein may be changed without departing from the scope of the subject matter described herein. Furthermore, the foregoing description is for the purpose of illustration only, and not for the purpose of limitation, as the subject matter described herein is defined by the claims as set forth hereinafter.

What is claimed is:

1. A method for controlling distribution of network management messages concerning the status of a destination when the destination is reachable via multiple routes keyed by different combinations of parameters, the method comprising:
(a) provisioning a routing node with a primary route to a destination and at least one exception route to the destination, wherein the primary route and the exception route are keyed by different combinations of signaling message parameters;
(b) detecting an event concerning the status of the destination on a linkset corresponding to the exception route;
(c) updating the status of the exception route in a route table maintained by the routing node; and
(d) suppressing broadcasting of network management messages concerning the status of the destination to nodes adjacent to the routing node.

2. The method of claim 1 wherein detecting an event concerning the status of the destination includes receiving a network management message concerning the status of the destination.

3. The method of claim 1 wherein detecting an event concerning the status of the destination includes detecting the failure of a linkset corresponding to an exception route.

4. The method of claim 2 wherein receiving a network management message concerning the status of a destination includes receiving one of a transfer prohibited (TFP) message, a transfer restricted (TFR) message, a transfer cluster prohibited (TCP) message, and a transfer cluster restricted (TCR) message.

5. The method of claim 1 wherein the routing node comprises a signal transfer point (STP).

6. The method of claim 1 comprising:
(a) receiving a signaling message;
(b) determining whether parameters in the signaling message match routing key parameters of the exception route;
(c) in response to determining that the parameters in the signaling message match the routing key parameters of the exception route, routing the message over the exception route; and
(d) in response to determining that the parameters in the signaling message do not match the routing key parameters of the exception route, routing the signaling message over the primary route.

7. A method for selectively informing a node of the status of an exception route used as an exclusive route by a node to a destination, the method comprising:
(a) maintaining a route table in a routing node, wherein the route table includes a primary route to a destination that functions as a fall-through route to the destination, a plurality of exception routes to the destination, wherein the exception routes are keyed by different combinations of parameters than the primary route, and wherein at least one of the exception routes comprises an exclusive route to the destination for an originating node;
(b) detecting, over a linkset corresponding to the exclusive route, a an event concerning the status of the destination;
(c) updating the status of the exclusive route based on the event; and
(d) sending a network management message indicating the status of the destination to the originator and suppressing the sending of the network management message to nodes that use the remaining exception routes and the primary route to the destination.

8. The method of claim 7 wherein detecting an event concerning the status of the destination includes receiving a network management message concerning the status of the destination.

9. The method of claim 7 wherein detecting an event concerning the status of the destination includes detecting the failure of the linkset corresponding to an exception route.

10. The method of claim 7 wherein the routing node comprises a signal transfer point (STP).

11. The method of claim 8 wherein receiving a network management message includes receiving one of a transfer restricted (TFR) message, a transfer prohibited (TFP) message, a transfer cluster restricted (TCR) message, and a transfer cluster prohibited (TCP) message.

12. The method of claim 7 comprising selectively testing the status of the exclusive route and informing the originator of the status.

13. The method of claim 12 wherein selectively testing the status of the exclusive route includes sending a route set test (RST) message over the linkset corresponding to the exclusive route.

14. A method for communicating exception route status among nodes that use a primary route and at least one exception route to a destination where the routes are keyed by different combinations of parameters, the method comprising:
(a) detecting an event concerning the status of an exception route to a destination in a node that maintains a primary route and at least one exception route to the destination, wherein the primary route and the exception route are keyed by different combinations of signaling message parameters;
(b) generating a network management message including at least one parameter that uniquely identifies the exception route that the event concerns; and
(c) communicating the network management message to at least one adjacent node.

15. The method of claim 14 comprising communicating a network handshake message to at least one adjacent node for determining whether the at least one adjacent node is capable of processing the network management message.

16. The method of claim 14 wherein generating the network management message includes identifying the exception route by a destination point code and at least one parameter in addition to the destination point code.

17. The method of claim 16 wherein the at least one additional parameter includes at least one of an originating point code, an originating linkset, a service indicator, and a circuit identifier code.

18. The method of claim 14 wherein the originating node selectively tests the exception route by sending a network management message that uniquely identifies the exception route to the destination.

19. The method of claim 18 wherein the network management message used to test the exception route identifies the exception route by a destination point code and at least one of an originating point code, an originating linkset, a service indicator, and a circuit identifier code.

20. A method for providing tiered quality of service for routing signaling messages and for providing network management to maintain the tiers, the method comprising:
(a) providing a first high speed route for a first customer with fall-through to a low speed route in response to unavailability of the high speed route;
(b) providing a low speed route for routing signaling message traffic of a second customer; and
(c) selectively performing network management for the high speed route and the low speed route.

21. The method of claim 20 wherein the high speed route comprises an SS7 over IP route and the low speed route comprises an SS7 over time division multiplexed (TDM) route.

22. The method of claim 20 wherein the high speed and low speed routes are keyed by different originating point code parameters.

23. The method of claim 20 wherein selectively performing network management includes, in response to failure of the high speed route, refraining from sending network management messages concerning the status of the high speed route, and in response to failure of the low speed route, sending a network management message exclusively to the second customer.

24. A signaling message routing node for controlling distribution of network management messages concerning the status of a status link, the node comprising:
(a) a route table embodied in a computer readable medium, the route table including a primary route to a destination and at least one exception route to the destination wherein the primary route and the exception route are keyed by different combinations of signaling message parameters; and
(b) a route manager for detecting an event concerning the status of the destination on a linkset corresponding to the exception route, for updating the status of the exception route in a route table maintained by the routing node, and for suppressing broadcasting of network management messages concerning the status of the destination to nodes adjacent to the routing node.

25. A signaling message routing node for controlling generation of a network management message to test the status of a route in a signaling message routing node that includes a plurality of routes that use the same linkset and that have different routing criteria, the signaling message routing node comprising:
(a) a route table embodied in a computer readable medium, the route table including a plurality of routes corresponding to the same linkset, wherein the plurality of routes are keyed by different combinations of signaling message parameters; and
(b) a route manager for detecting an event concerning the status of the destination on the linkset, for updating the status of the plurality of routes corresponding to the linkset based on the network management message, for invoking a single route set test procedure on behalf of the plurality of routes, and for updating status of each of the routes based on a result of the testing.

26. A signaling message routing node for controlling generation of a network management message to test the status of a route in a signaling message routing node that includes a plurality of routes that use the same linkset and that have different routing criteria, the signaling message routing node comprising:
(a) a route table embodied in a computer readable medium, the route table including a primary route to a destination that functions as a fall-through route to the destination and a plurality of exception routes with the destination, wherein the exception routes are keyed by different combinations of parameters than the primary route, and wherein at least one of the exception routes comprises an exclusive route to a destination for an originating node; and
(b) a route manager for detecting an event concerning the status of the exclusive route and updating the status of the exclusive route based on the network management message, for sending a network management message indicating the status of the exclusive route to the originator and suppressing sending of network management messages concerning the exclusive route to nodes that use the remaining exception routes and the primary route to the destination.

27. A signaling message routing node for communicating exception route status among nodes that use a primary route and at least one exception route to a destination where the routes are keyed by different cognations of parameters, the signaling message routing node comprising:
(a) a route table embodied in a computer readable medium, the route table including a primary route and at least one exception route to a destination, wherein the primary route and the exception route are keyed by different combinations of signaling message parameters; and
(b) a route manager for detecting an event that affects the status of an exception route to a destination and generating, based on a network management message, a network management message including a plurality of parameters that uniquely identify the affected exception route, and for communicating the network management status message to at least one adjacent node.

28. A signaling message routing node for providing tiered quality of service for routing signaling messages and for providing network management to maintain the tiers, the signaling message routing node comprising:
(a) a route table embodied in a computer readable medium, the route table including a first high speed route with fall-through to a low speed route; and
(b) a route manager for providing the high speed route for routing signaling message traffic of a first customer and, in response to unavailability of the high speed route, providing the low speed route for routing signaling message traffic of the first customer, for providing the low speed route for routing signaling message traffic of a second customer, and for selectively performing network management for the high speed route and the low speed route.

29. A computer program product comprising computer executable instructions embodied in a computer readable medium for performing steps comprising:
(a) provisioning a routing node with a primary route to a destination and at least one exception route to the destination wherein the primary route and the exception route are keyed by different combinations of signaling message parameters;
(b) detecting an event concerning the status of the destination on a linkset corresponding to the exception route;
(c) updating the status of the exception route in a route table maintained by the routing node; and
(d) suppressing broadcasting of network management messages concerning the status of the destination to nodes adjacent to the routing node.

30. A computer program product comprising computer executable instructions embodied in a computer readable medium for performing steps comprising:
(a) provisioning a routing node with a plurality of routes corresponding to the same linkset, wherein the plurality of routes are keyed by different combinations of signaling message parameters;
(b) detecting an event concerning the status of the destination on the linkset;
(c) updating the status of the plurality of routes corresponding to the linkset based on the network management message;
(d) invoking a single route set test procedure on behalf of the plurality of routes; and
(e) updating the status of each of the routes based on a result of the testing.

31. A computer program product comprising computer executable instructions embodied in a computer readable medium for performing steps comprising:
(a) maintaining a route table in a routing node, wherein, the route table includes a primary route to a destination that functions as a fall-through route to the destination, a plurality of exception routes with the destination, wherein the exception routes are keyed by different combinations of parameters than the primary route, and wherein at least one of the exception routes comprises an exclusive route to a destination for an originating node;
(b) detecting an event concerning the status of the exclusive route;
(c) updating the status of the exclusive route based on the network management message; and
(d) sending a network management message indicating the status of the exclusive route to the originator and suppressing sending of network management messages concerning the status of the exclusive route to nodes that use the remaining exception routes and the primary route to the destination.

32. A computer program product comprising computer executable instructions embodied in a computer readable medium for performing steps comprising:
(a) detecting an event that affects the status of an exception route to a destination in a node that maintains a primary route and at least one exception route to the destination, wherein the primary route and the exception route are keyed by different combinations of signaling message parameters;
(b) generating, based on a network management message, a network management message including a plurality of parameters that uniquely identify the affected exception route; and
(c) communicating the network management status message to at least one adjacent node.

33. A computer program product comprising computer executable instructions embodied in a computer readable medium for performing steps comprising:
(a) providing a first high speed route for a first customer with fall-through to a low speed route in response to unavailability of the high speed route;
(b) providing the low speed route for routing signaling message traffic of a second customer; and
(c) selectively performing network management for the high speed route and the low speed route.
